(19) United States
(12) Patent Application Publication
(10) Pub. No.: US 2007/0205274 A1
(43) Pub. Date: Sep. 6, 2007

(54) Customer retrievable electronic receipt

(76) Inventor: Bobbie Jo Bridges, Covington, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/369,639

(22) Filed: Mar. 6, 2006

(51) Int. Cl. G06K 15/00; G07G 1/12

(52) U.S. Cl. 235/383; 705/24

(57) ABSTRACT

A method program and a computer readable medium facilitate generating of an electronic receipt of a sales transaction at a point of purchaser and transmitting the record in an electronic form to be retrieved by a buyer. The electronic receipt is a computer image representation of corresponding paper receipt of said sales transaction, identifying, inter alia, the type of product or service bought and paid for by the customer. The record of the sales transaction may be transmitted to a portable memory storage device in possession of the buyer at the point of purchase, or to a remote service provider, or to an Internet-supported electronic address of the buyer. The records are stored in a computer-readable form, allowing the buyer retrieval of the records based on categories of purchase as defined by conventional accounting methods.

### BACKGROUND OF THE INVENTION

The present invention relates to an electronic transaction and more particularly to a method for generating a record of a sale transaction in an electronic format.

Virtually every retail transaction involves issuance of a receipt to the customer identifying the transaction, as well as the type of product or service bought by the customer. Most often customers are provided with a paper receipt at the time of purchase. The customer may need to retain the receipts for a variety of reasons, such as for instance requesting a refund for a returned item, identifying the warranty date, for tax purposes and the like. The paper receipts may not be reliable at a future date since some receipts are printed on thermal paper, and images on such paper disappear when the receipt is exposed to light or with the passage of time. The printed paper receipts can also be damaged by exposure to moisture, destroyed by fire, lost or torn.

Additionally, consumers often have difficulty in organizing the receipts by the type of purchases made, which may be important for segregating the receipts for tax reporting purposes. If the paper receipts are poorly maintained, consumers can spend hours at tax preparation time to separate receipts that identify tax-deductible products or services. Additionally, the paper receipts create an unwanted clutter in a home or office.

Another problem associated with the current system of paper receipts is that the receipts are often updated at the time the sales transaction is altered or voided. This can be a negative factor for merchants due to the fact that items can be returned or sales can be recalculated on an invalid receipt. Sometimes a fraudulent activity can be conduct with such an antiquated system.

There exists therefore a need for a reliable, easily maintained system and method for generating a record of a sales transaction in an electronic form accessible by the user.

### SUMMARY OF THE INVENTION

It is therefore an object of the present invention to provide a method of collecting data corresponding to retail sales, in an electronic form, to be accessible by the user.

It is another object of the present system to provide a method and system for collecting data for retail sales accessible by the user through the Internet or other communication means.

These and other objects of the present invention are obtained through a provision of a method of generating an electronic receipt of a sales transaction at a point of purchaser and transmitting the record in an electronic form to be retrieved by the buyer. The electronic receipt is a computer image representation of corresponding paper receipt of said sales transaction, identifying, inter alia, the type of product or service bought and paid for by the customer.

The record of the sales transaction may be transmitted to a portable memory storage device in possession of the buyer at the point of purchase, or to a remote service provider, or to an Internet-supported electronic address of the buyer. The records are stored in a computer-readable form, allowing the buyer retrieval of the records based on categories of purchase as defined by conventional accounting methods.

If desired, the electronic sales receipt may contain data on product warranty, discount of a business promotion applied to the purchase price, seller's product return policy and the like.

The invention also provides a computer readable medium storing a computer program, which when executed by a computer, causes the computer to perform the steps of generating an electronic record of a sales transaction at a point of purchase between a seller and a purchaser, and transmitting the record of the sales transaction in an electronic form to be retrieved by the purchaser.

The electronic record is a computer image representation of corresponding paper receipt of the sales transaction.

### BRIEF DESCRIPTION OF THE DRAWING

Reference will now be made to the drawing, wherein like parts are designated by like numerals, and wherein

FIG. 1 is a schematic diagram of the method of generating an electronic receipt suitable for customer access in accordance with the present invention.

### DETAILED DESCRIPTION OF THE PREFERRED EMBODIMENT

The present invention provides for a method of generating a record, in an electronic form of a sales transaction between a seller of goods or services and a customer. The records are generated following a live transaction involving the seller and the customer. The sales transaction may include sales in the purchase of products and/or services, wherein the purchaser is present during transaction. Such sales can be conducted in a retail or wholesale store, at the counter of a service provider, such as a restaurant, hotel and the like.

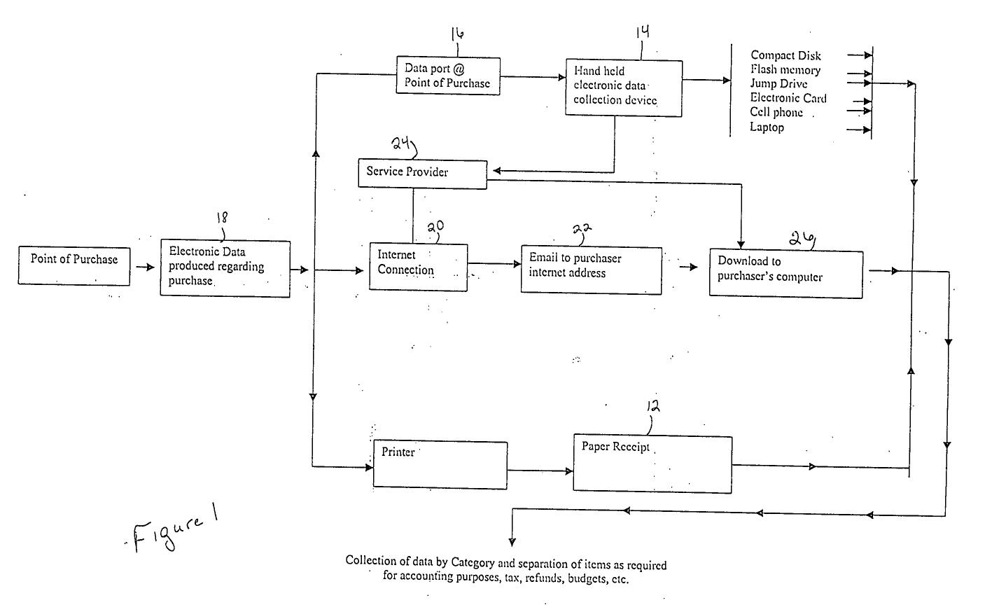

The seller charges the customer for the product or service in a regular course of business. The financial transaction results in the generation of a bill or invoice for the goods/services provided by the seller. In contrast to a conventional bill or invoice, the method of the present invention provides for the seller's computer generating the bill in an electronic format in accordance to a set of instructions or codes installed in the seller's computer. The customer pays for the service in a variety of methods, such as by cash, credit or debit card, and the like. The customer elects the type of receipt the customer desires to obtain from the merchant. The receipts can be printed on paper, such as schematically shown in FIG. 1 and designated by numeral 12 or in an electronic format that is compatible with the program installed in a customer-accessible hardware device. The electronic receipt can be generated in a number of ways. The merchant has a module or a payment processing station, such as a checkout counter, which collects the customer code encoded in a hand-held electronic memory device 14. The customer code is pre-established by the software installed in the seller's computer and in the customer-accessible memory device. Both the seller and the customer are provided with unique identification data, or code that identifies the seller and the customer. The identification data can be retained by the seller and customer, or stored in the database of a service provider 24.

The transaction data can be transmitted through the data port 16 of the memory device 14 according to a number of electronically assisted methods. For instance, the data collection device 14 can be a hand held unit capable of receiving infrared communications, or it can be a wireless telephone, PDA, or any other suitable device equipped to receive the signal transmitted by the electronic data transmission technology. The hand held electronic data collection device can work with other known existing technology or technology that can be developed in the future.

The merchant can also employ a number of technology-assisted devices 18 that are capable of generating the electronic data regarding the sales transaction. The merchant's device can be suitably equipped to generate the infrared signal, a wireless signal, a radio high frequency signal and the like. The device 18 can be a stand alone dedicated unit or a software program that can be incorporated in the computer registers capable of generating conventional paper receipts or electronic receipts. It is envisioned that the device 18 can be suitably programmed to generate only electronic receipts, if necessary, when the merchant or service provider does not have a conventional cash register capable of generating a paper receipt.

The device 10 can be also programmed to transmit the data relating to the retail transaction through the Internet device 20 to the customer's Internet address 22. The merchant may not know the exact Internet address although the purchaser's memory device 14 can store the encoded information and make it accessible only in a computer-readable form that can be utilized by the merchant's receipt generating device 18.

The electronic device 18 generates the electronic receipt which is a computer image representation of the corresponding paper receipt of the sales transaction. If the customer chooses to have the transaction records forwarded to the service provider 24, the receipt information is forwarded to the computer of the service provider 24, which is made accessible to the customer through the customer computer 26.

The electronic service provider 24 can be requested to analyze the data received from the merchant and store a copy of the receipt similar in the form of a standard receipt. The service provider 24 can be also requested to separate the customer's receipt information into the categories according to accounting methods, based on the type of product or service paid for by the customer. This can be a product for individual needs, tax deductible items, entertainment, food and beverage, office/beauty supplies, medical bills, household expenses, hotels, transportation expense and the like. The receipt can be downloadable to the customer's computer 26 upon demand or monthly, weekly, etc., depending on the type of service provided by the provider 24.

The customer in turn can print the receipt in a paper form if the customer needs to return the item to the retailer. The customer can also rely on the server 24 to provide similar information to the merchant's device 18 if the customer needed to return the item or if a proof of purchase is required. The encoded data relating to the customer's account can be reviewed by the customer or trusted individuals, such as customer tax advisors and accountants for the purpose of preparing tans returns, budgets, itemization of expenses and the like.

The customer may also organize and retrieve information from the memory device 14 to determine the everyday expenditures by categories of times, places of purchase, dates of purchase or pricing levels. The customer may access or import information for purposes of reconciling banking and credit statements and easily determine any discrepancies between the receipt at the time of purchase and the data stored in the device 14 or received by the server 24. Such collection of data will make it easier for the customer to immediately detect potential fraudulent purchases made by unauthorized individuals. The server 24 cannot alter the receipt which is saved only as “read only” file.

The server 24 can be requested to provide periodic statements to the customer and to the merchant to allow easy organization of the items as well as the tracking of the expenses paid by the customer with the customer number.

The server provider 24 similarly collects data from the customer's hand held electronic data collection device 14. The device 14 can store information on a compact disk, in flash memory, in junk drive, on an electronic card, in a cell phone or laptop computer and other storage means now know or developed in the future.

On the retailer's end, the seller's device 18 allows the customers to record the electronic receipt information at the point of sale. If the customer returns merchandise the merchant either credits the customer and generates an electronic proof of refund or prints a paper receipt showing the returned item and credit either to customer's account with the merchant, or through credit card reverse charges, or by cash. The service provider 24 may also retain information on the exact amount paid by the customer including any promotional discounts, coupons, etc. Based on the exact amount paid by the customer, the credit can be issued for that amount only regardless of other types of discounts applied at the point of purchase.

The service provider 24 can also alert the customer of the expiration date for the item return based on the merchant/retailer's policy. The electronic receipt generated by the server 24 provides proof of return/purchase guideless of a particular retailer that can be easily downloaded and reviewed by the customer in the customer's account information. Similarly, the data downloaded into the memory device 14 can be processed to retain the information of the seller's return policy and warranty expiration associated with a particular file containing the electronic receipt.

The method of the present invention prevents the consumers from returning the merchandise without receiving customer store credit and prevents items purchased from one store being returned to another location where a particular product may no longer be carried by the merchant. In this manner, the merchant will avoid having to reconcile the inventory and refuse to accept the items not corresponding to the original purchase. It is envisioned that the mistakes between the customer and merchant can be substantially reduced when the receipts are stored in an electronic form, and a disinterested third party such as the service provider 24, acts as an intermediary by retaining copies of the receipts that cannot be altered by either the customer or the merchant.

The present invention also provides for a computer readable medium, which stores a computer program that when executed by a computer, causes the computer to perform the steps of generating an electronic record of a sales transaction at a point of purchase between a seller and a purchaser, and transmitting the record of the sales transaction in an electronic form to be retrieved by the purchaser.

The electronic record in the computer readable medium is a computer image representation of corresponding paper receipt of the sales transaction between a seller and a customer executed at the point of purchase of a product or service. The step of transmitting the record comprises transmitting the data of the sales transaction to a portable memory device in possession of the purchaser at the point of purchase, or to a remote service provider for storage and subsequent retrieval by the purchaser, or to an Internet-supported electronic address of the purchaser.

The step of transmitting the record comprises the step of identifying the seller and the purchaser by unique identification data to facilitate association of the record of the sales transaction with a corresponding electronic file of the seller or the purchaser. In accordance with the present invention, the program causes the computer to perform the step of organizing the purchaser's records of a plurality of sales transactions according to acceptable accounting methods.

It is envisioned that various other methods for receiving the signal generated by the merchant's device 18 can be employed, such as by a personal handheld computing device, by a barcode scanner. The SKU number can be embedded in a barcode sticker and encoded before being downloaded to the memory device 14. The memory device 14 can be carried on a key chain, in a form of a credit card, and in many other physical embodiments.

The customer's memory device 14 can be provided by an employer for use when charging to an expense account established by the employer. The device 14 is then turned over to the accounting personnel for retrieval of data to provide the employer with an accurate account of expenses incurred by the employee on behalf of the employer. The reports of the expenses can be similarly transmitted through the Internet connection of the employer and can then be retrieved and downloaded by the accounting personnel in a normal cause of business.

It is envisioned that the method of the present invention can be utilized for preparing, recording and accounting expenses attributed to coupons and discounts, thus avoiding any potential for providing credit to the customer for more than the customer spent at an actual establishment.

Many changes and modifications can be made in the method of the present invention without department from the spirit thereof. I therefore pray that my rights to the present invention be limited only by the scope of the appended claims.

I claim:

1. A method of generating a record of a sales transaction between a seller and a purchaser, comprising the steps of:
generating an electronic record of a sales transaction at a point of purchase; and
transmitting the record of the sales transaction in an electronic form to be retrieved by the purchaser.

2. The method of claim 1, further comprising the step of providing the seller with unique identification data and providing the purchaser with unique identification data.

3. The method of claim 1, wherein the record of the sales transaction is transmitted to an electronic device controlled by the purchaser at the point of purchase.

4. The method of claim 1, wherein the record of the sales transaction is transmitted to a remote service provider for storage and subsequent retrieval by the purchaser.

5. The method of claim 1, wherein the record of the sales transaction is transmitted to an Internet-supported electronic address of the purchaser.

6. The method of claim 1, wherein the record is transmitted in a computer-readable form.

7. The method of 6, wherein the record comprises is a computer image representation of corresponding paper receipt of said sales transaction.

8. The method of claim 1, wherein the record of the sales transaction comprises an itemized receipt containing at least data of a date of the sales transaction, a type of product or service provided to the purchaser by a seller, price paid by the purchaser and method of payment used by the purchaser.

9. The method of claim 8, wherein the itemized receipt further comprises data on seller's merchandise return policy.

10. The method of claim 8, wherein the itemized receipt further comprises data of product warranty terms.

11. The method of claim 8, wherein said itemized receipt comprises data on any discount offered by the seller according to a business promotion and applied towards the purchase price paid by the purchaser.

12. The method of claim 1, further comprising the steps of organizing purchaser's records of a plurality of sales transactions according to acceptable accounting methods.

13. The method of claim 12, further comprising the steps of facilitating retrieval of sales transactions records by the purchaser according to categories of sales transactions.

14. The method of claim 3, wherein the electronic device controlled by the purchaser is a portable memory device.

15. The method of claim 14, wherein said portable memory device is a compact disk.

16. The method of claim 14, wherein said portable memory device is a flash memory product.

17. The method of claim 14, wherein said portable memory device is a jump drive product.

18. The method of claim 14, wherein said portable memory device is an electronic card.

19. The method of claim 14, wherein said portable memory device is a cellular telephone.

20. The method of claim 14, wherein said portable memory device is a portable computer.

21. A computer readable medium storing a computer program, which when executed by a computer, causes the computer to perform the steps of generating an electronic record of a sales transaction at a point of purchase between a seller and a purchaser, and transmitting the record of the sales transaction in an electronic form to be retrieved by the purchaser.

22. The computer readable medium of claim 21, wherein the electronic record is a computer image representation of corresponding paper receipt of said sales transaction.

23. The computer readable medium of claim 21, wherein the step of transmitting the record comprises transmitting the data of the sales transaction to a portable memory device in possession of the purchaser at the point of purchase.

24. The computer readable medium of claim 21, wherein the step of transmitting the record comprises transmitting the data of the sales transaction to a remote service provider for storage and subsequent retrieval by the purchaser.

25. The computer readable medium of claim 21, wherein the step of transmitting the record comprises transmitting the data of the sales transaction to an Internet-supported electronic address of the purchaser.

26. The computer readable medium of claim 24, wherein the step of transmitting the record comprises the step of identifying the seller by unique identification data to facilitate association of the record of the sales transaction with a corresponding electronic file of the seller.

27. The computer readable medium of claim 24, wherein the step of transmitting the record comprises the step of identifying the purchaser by unique identification data to facilitate association of the record of the sales transaction with a corresponding electronic file of the purchaser.

28. The computer readable medium of claim 21, wherein the program causes the computer to perform the step of organizing the purchaser's records of a plurality of sales transactions according to acceptable accounting methods.
